(19) United States
(12) Patent Application Publication
(10) Pub. No.: US 2010/0084550 A1
(43) Pub. Date: Apr. 8, 2010

(54) Apparatus and Method for Identifying Metalloproteins

(75) Inventors: Viorica Lopez-Avila, Sunnyvale, CA (US); Gangqiang Li, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/246,586

(22) Filed: Oct. 7, 2008

(51) Int. Cl. H01J 49/40

(52) U.S. Cl. 250/287

(57) ABSTRACT

A device and a method for identifying metalloproteins are disclosed. The device includes a first separation device for separating sample molecules according to their retention times, a first ionization device for ionizing the separated molecules into molecular ions, a second separation device for separating the molecular ions by their size-to-charge ratio, a second ionization device for atomizing the molecular ions and creating atomic ions of interest, and a mass spectrometer for separating and identifying both the molecular ions and the atomic ions by their mass-to-charge ratios. A method includes separating sample molecules according to their retention time, ionizing the separated molecules to form molecular ions, separating the molecular ions according to their size-to-charge ratio, atomizing and ionizing a portion of the molecular ions and identifying the atomic and molecular ions by their mass-to-charge ratio.

### BACKGROUND

Metalloproteins represent almost one third of all human proteins. Proteins within this large group must be identified if the goal of identifying all human proteins is to be realized.

Because of the complexity of human plasma and serum, the current analytical techniques for identifying constituent metalloproteins use several different methods and instruments, either separately or in combination. For example, a multidimensional separation using a high performance liquid chromatograph (HPLC) is first performed to separate the proteins in the serum or plasma by their respective retention times. The effluent from the chromatograph is then split between an inductively coupled plasma mass spectrometer (ICPMS) for detection of metal ions, and an electrospray ionization (ESI) mass spectrometer or a matrix assisted laser desorption/ionization (MALDI) mass spectrometer for the identification of molecular ions. This analytical technique requires at least two mass spectrometers, the coordination of the apparatus is complicated, and sample analysis is time consuming. In another example, a high performance liquid chromatograph is used to separate proteins by their respective retention times and the effluent from the chromatograph is provided to an ion mobility spectrometer (IMS), which performs a second separation based upon the size-to-charge ratio of the proteins. After the second separation the proteins are provided to a time-of-flight (TOF) mass spectrometer for separation and detection according to their drift time through the time-of-flight analyzer. Results using this technique as reported by Valentine et al, “Toward Plasma Proteome Profiling with Ion Mobility-Mass Spectrometry in the Journal of Proteome Research, 2006, 5, 2977-2984, indicate enormous complexity and produce results whose great complexity makes them difficult to interpret.

### BRIEF DESCRIPTION OF THE DRAWINGS

FIG. 1 is a block diagram showing an exemplary dual mode mass spectrometer according to the invention;

FIG. 2 is a block diagram showing another exemplary dual mode mass spectrometer according to the invention;

FIG. 3 is a block diagram showing another embodiment of an exemplary dual mode mass spectrometer according to the invention;

FIG. 4 is a flow chart which illustrates a method according to an embodiment of the invention;

FIG. 5 is a flow chart which illustrates a method according to another embodiment of the invention;

FIG. 6 is a schematic view of an ionization chamber having a variable energy photoionization device used with the dual mode mass spectrometer according to the invention;

FIG. 7 is a plan view of substrate 68 with containment structure 70 removed;

FIG. 8 is a plan view of substrate 68 with containment structure 70 in place;

FIG. 9 is a cross sectional view taken at line 9-9 of FIG. 8;

FIG. 10 is a three dimensional plot of mass-to-charge ratio versus chromatograph retention time and ion mobility drift time in an analysis of superoxide dismutase expected to be created by a method and an apparatus according to the invention; and

FIG. 11 is a three dimensional plot of mass-to-charge ratio versus chromatographic retention time and ion mobility drift time in an analysis of various molecular ions of interest expected to be created by a method and an apparatus according to the invention.

### DETAILED DESCRIPTION

Embodiments of the invention provide a dual mode mass spectrometer capable of analyzing sample molecules comprising metalloproteins and identifying both their constituent atomic and molecular species. An example of a dual mode mass spectrometer comprises a first separation device for separating sample molecules according to their respective retention times. The first separation device is in fluid communication with a first ionization device for ionizing the sample molecules into molecular ions after separation. A second separation device is in fluid communication with the first ionization device and separates the molecular ions according to their size-to-charge ratio. A second ionization device is in fluid communication with the second separation device and receives the molecular ions separated according to their size-to-charge ratio. When the second ionization device is in operation it atomizes the molecular ions to generate respective atomic ions. The atomic ions comprise metal ions of interest. A mass spectrometer is in fluid communication with the second ionization device and, when the second ionization device is in operation, the mass spectrometer receives the atomic ions for separating and identifying them by their mass-to-charge ratios. When the second ionization device is not in operation the mass spectrometer receives the molecular ions from the second separation device for separating and identifying them according to their mass-to-charge ratios.

Embodiments of the invention further comprise a method of analyzing sample molecules comprising metalloproteins and identifying both their constituent atomic and molecular species. The method comprises separating sample molecules according to their respective retention times. The sample molecules thus separated are then ionized into respective molecular ions. The molecular ions constitute ions of a first ion type. The molecular ions are next separated according to their size-to-charge ratio. A portion of the molecular ions thus separated are atomized into atomic ions comprising metal ions of interest. The atomic ions constitute ions of a second type. The ions of each of the ion types are then sequentially subject to a common identification process to identify their respective molecular and atomic species. The identification process comprises separating the ions of the respective ion type according to their mass-to-charge ratio and detecting the ions of the respective ion type separated according to their mass-to-charge ratio.

FIG. 1 is a block diagram showing an example of an embodiment of a dual mode mass spectrometer 10 according to the invention. Dual mode mass spectrometer 10 comprises a first separation device 12 in fluid communication with a first ionization device 14. First ionization device 14 is in fluid communication with a second separation device 16, which in turn is in fluid communication with a second ionization device 18. The second ionization device is in fluid communication with a mass spectrometer 20. The first separation device 12, the second separation device 16 and the mass spectrometer 20 are all capable of outputting respective signals 13, 17 and 21 from which useable data can be generated as described below.

In the exemplary dual mode mass spectrometer 10, the first separation device 12 separates sample molecules according to their retention time in the separation device, thereby providing one dimension of the analysis for generating a spectrograph. At least two devices have desired characteristics which make them useable as the first separation device 12. A high performance liquid chromatograph (HPLC), which is currently used for protein separation, provides versatility, adequate resolution and reproducibility, ease of selectivity manipulation and good recoveries, meaning that a relatively high percentage of the proteins from the sample are not lost by adsorption onto the stationary phase used in HPLC. In an alternative embodiment, the first separation device 12 comprises a capillary electrophoresis (CE) device. The CE device is suitable for high-speed separations. It further has adequate resolution and does not require extensive method development, the procedures being relatively straightforward and simple.

The first ionization device 14 ionizes the molecules separated in the first separation device 12. In the analysis of human proteins, these molecules are large, complex biological molecules which are easily fragmented. To prevent excessive fragmentation and thereby provide an abundance of molecular ions for analysis, a candidate for the first ionization device 14 is an electrospray ionization device. Electrospray ionization devices are known to produce molecular ions from macromolecules with limited fragmentation. Another ionization device which ionizes large molecules without excessive fragmentation is a photoionization device. In particular, a variable energy windowless photoionization device as disclosed in U.S. patent application Ser. No. 12/189,348 and described below, can be used as the first ionization device 14.

The second separation device 16 separates the molecular ions generated by the first ionization device 14 in accordance with their size-to-charge ratios. The second separation provides a second analysis dimension for generation of the spectrograph. The molecular ions are separated in accordance with their size-to-charge ratios by using an ion mobility spectrometer as the second separation device 16. An ion mobility spectrometer effectively measures the speed at which ions move through a known atmosphere under a uniform electric field. The speed of the ions of a given species depends on their size-to-charge ratio. Use of the ion mobility spectrometer in the identification of metalloproteins permits the molecular ions to be separated by their size-to-charge ratio. This allows the metalloprotein molecular ions which still retain their metal co-factor to be separated from those which do not, as the metalloprotein ions with the metal co-factor will be folded and therefore have a smaller ionization cross section than those molecules which do not have the metal co-factor, and will therefore be at least partially unfolded. The smaller (folded) molecular ions will pass through the ion mobility spectrometer faster than the larger (unfolded) molecular ions and are therefore separated in accordance with their size-to-charge ratios.

The dual mode aspect of the dual mode mass spectrometer 10 is embodied in the second ionization device 18. Second ionization device 18, when in operation, atomizes and ionizes the molecular ions received from the second separation device 16 so that only atomic species of interest will be detected by the downstream mass spectrometer 20. In the identification of metalloproteins, the atomic species of interest comprise the metal elements constituting the proteins. An inductively coupled plasma torch is used as the second ionization device. The inductively coupled plasma torch provides a sustained plasma by using a rapidly oscillating magnetic field to induce collisions between electrons and atoms of an inert gas, such as argon. Sustained plasmas having temperatures as high as 10,000° K are produced, and molecular ions from the second separation device 16, when subject to the plasma, are readily atomized and ionized so to produce atomic ions that are input to mass spectrometer 20.

When the second ionization device 18 is not in operation the molecular ions produced by the first ionization device 14 and separated by the second separation device 16 are input to the mass spectrometer 20.

Mass spectrometer 20 separates and detects ions (atomic ions when second ionization device 18 is activated to atomize the molecular ions output by second separation device 16, and molecular ions otherwise) according to their mass-to-charge ratio, and thereby provides a third analysis dimension for the generation of the spectrograph. The ions separated and detected by mass spectrometer 20 are atomic ions when second ionization device 18 is activated to atomize the molecular ions output by second separation device 16, and otherwise are molecular ions. A time-of-flight mass spectrometer is suitable for use as the mass spectrometer 20 because it has a broad mass range. The time-of-flight mass spectrometer can separate and detect ion masses ranging from a few daltons to several hundred thousand daltons. This broad mass range allows the dual mode mass spectrometer 10 to use a single mass spectrometer, i.e., mass spectrometer 20, to analyze both the atomic and molecular ions. In the analysis of metalloproteins by dual mode mass spectrometer 10, mass spectrometer 20 is used to identify both the metal co-factor and the molecular protein ion.

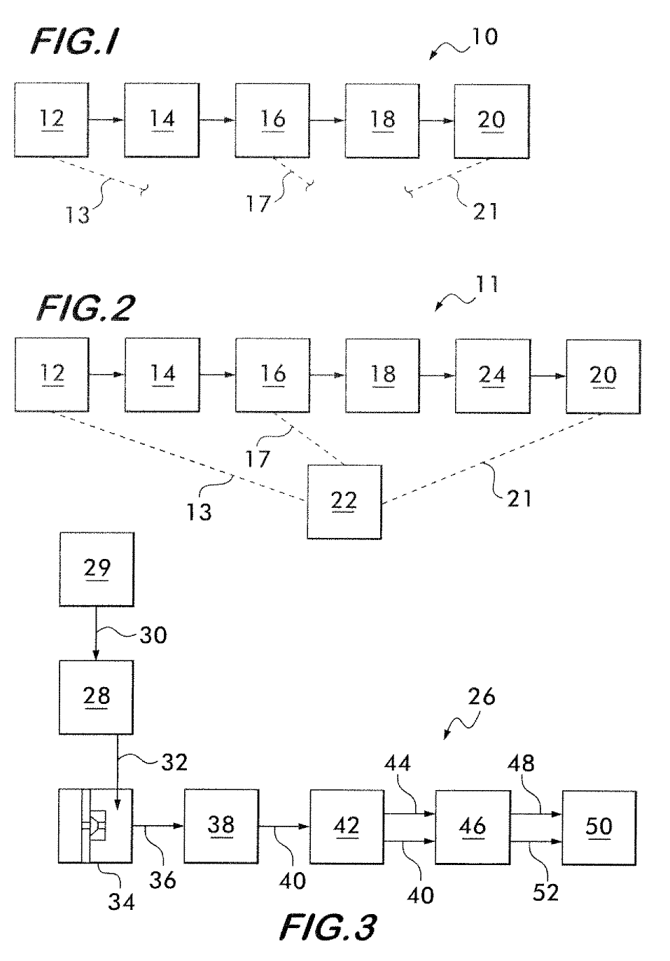

In an alternative embodiment 11, shown in FIG. 2, a multipole mass analyzer 24 is interposed between second ionization device 18 and mass spectrometer 20. Multipole mass analyzer 24 operates as a filter stage to eliminate polyatomic interferences. For example, argon oxide at m/z 56 interferes with the determination of iron at m/z 56. Dual mode mass spectrometer 11 also includes a data processing device 22. The data processing device is in communication with the first separation device 12, the second separation device 16 and the mass spectrometer 20. Data processing device 22 receives the respective signals 13, 17 and 21 from the above-mentioned separation devices 12 and 16 and the mass spectrometer 20 for the generation of useable data, for example, multi-dimensional spectrographs described below.

FIG. 3 is a block diagram showing an example of a specific embodiment 26 of a dual mode mass spectrometer according to the invention. The dual mode mass spectrometer 26 comprises a high performance liquid chromatograph 28 to which a molecular sample 30 comprising a metalloprotein is fed by a pump 29. Liquid chromatograph 28 separates the sample molecules 30 according to their retention times, yielding an effluent stream 32. Chromatograph 28 is in fluid communication with a windowless photoionization device 34 that constitutes a first ionization device. The sample molecules 32, separated according to their retention time in the chromatograph 28, are ionized by the photoionization device to create molecular ions 36. The molecular ions 36 then pass to an ion mobility spectrometer 38 where they are separated according to their size-to-charge ratio, the larger, unfolded molecular ions passing more slowly through the ion mobility spectrometer 38 than the more compact, folded molecular ions, which still comprise their respective metallic co-factors. The molecular ions 40, separated according to their size-to-charge ratio, are then passed to an inductively coupled plasma torch 42 in fluid communication with the ion mobility spectrometer 38. To identify the atomic ions of interest, the inductively coupled plasma torch 42 is operated to heat and thereby atomize the separated molecular ions 40 of interest to produce atomic ions 44. The atomic ions 44 are then subject to selection by a multipole analyzer 46 and the subset 48 of atomic ions 44 selected by the multipole analyzer are separated and detected according to their mass-to-charge ratio by a time-of-flight mass spectrometer 50. To analyze molecular ions 40 of interest, separated according to their size-to-charge ratio, the inductively coupled plasma torch 42 is not operated, and the molecular ions 40 pass to the multipole mass analyzer 46 which selects a subset 52 of the molecular ions 40. The selected molecular ions 52 are then separated and detected according to their mass-to-charge ratio by the time-of-flight mass spectrometer 50.

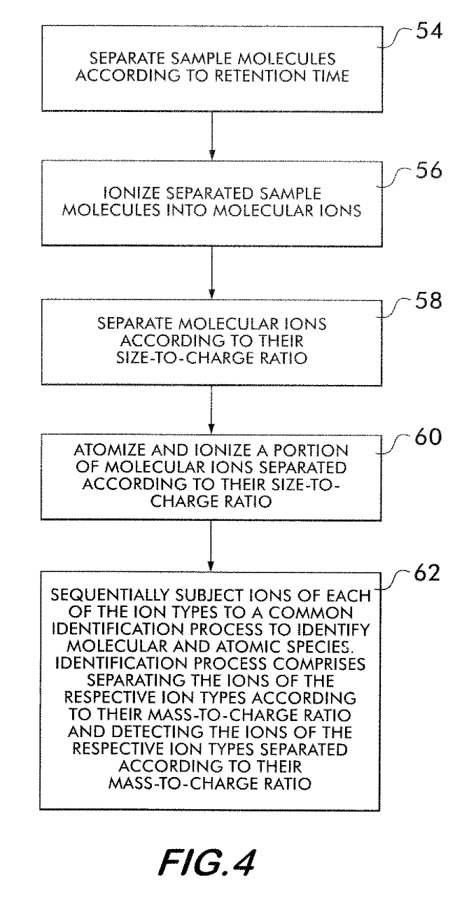

Embodiments of the invention also include a method of analyzing sample molecules comprising metalloproteins and identifying both their constituent atomic and molecular species. A flow chart illustrating an embodiment of the method is shown in FIG. 4. The illustrated method comprises separating the sample molecules according to their respective HPLC retention times or CE migration times, as indicated at 54. At 56, the sample molecules which were separated according to their retention or migration times are ionized into respective molecular ions. The molecular ions constitute ions of a first ion type. The molecular ions are separated according to their size-to-charge ratio at 58. A portion of the molecular ions, which were separated according to their size-to-charge ratio, are atomized and ionized to form atomic ions comprising metal ions of interest, as shown at 60. The atomic ions constitute ions of a second ion type. At 62, ions of each of the ion types are subject sequentially to a common identification process to identify the molecular and atomic species. The identification process comprises separating the ions of the respective ion type according to their mass-to-charge ratio and detecting the ions of the respective ion type separated according to their mass-to-charge ratio.

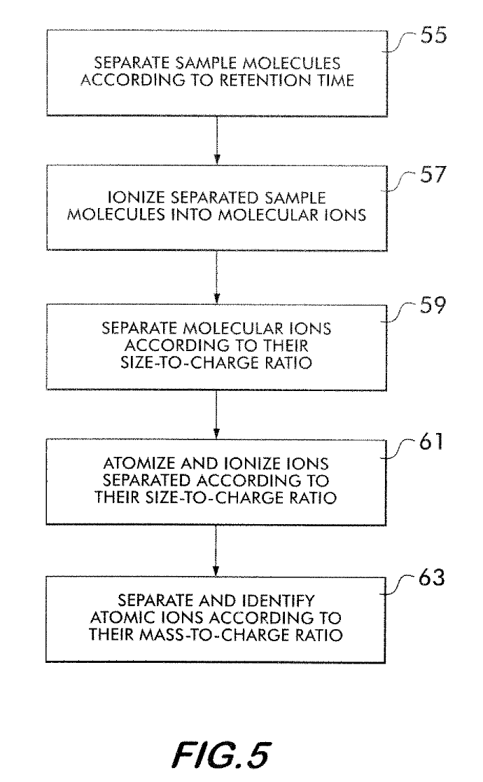

FIG. 5 is a flow chart which illustrates a method of analyzing sample molecules comprising metalloproteins and identifying their atomic species of interest. The method comprises separating the sample molecules according to their respective retention or migration times, as shown at 55. The separated molecules are then ionized into respective molecular ions at 57. At 59 the molecular ions are separated according to their size-to-charge ratio. After separation according to their size-to-charge ratio, the molecular ions are atomized and ionized into atomic ions comprising metal ions of interest as indicated at 61. The atomic ions are then separated and identified according to their mass-to-charge ratio as shown at 63.

In either method, separating the sample molecules according to their retention times is accomplished by HPLC or CE. Photoionization or electrospray ionization are ionizing methods which are used to ionize the sample molecules into molecular ions after they have been separated according to their HPLC retention times or CE migration times. Ion mobility spectrometry is used in either exemplary method to separate the molecular ions according to their size-to-charge ratio. Atomizing the molecular ions is accomplished by heating them using an inductively coupled plasma. Separating the atomic ions according to their mass-to-charge ratio is done using time-of-flight mass spectrometry.

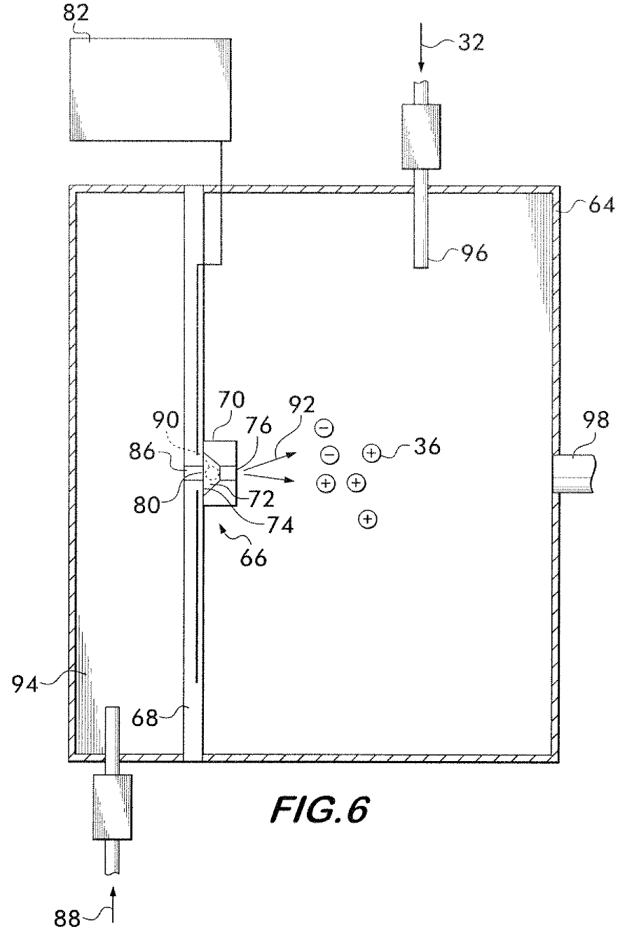

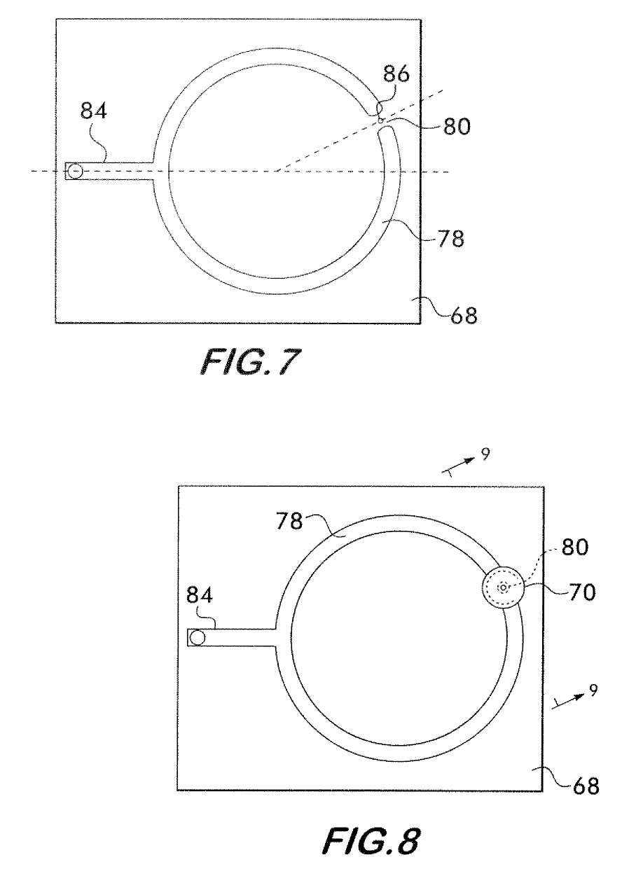

FIG. 6 is a schematic illustration of an ionization chamber 64 in which an example of a variable energy photoionization device 66 is located. Ionization device 66 comprises a substrate 68 on which is mounted a windowless plasma containment structure 70. Plasma containment structure 70 defines a plasma chamber 72 having an inlet aperture 74, and a windowless outlet aperture 76. As shown in FIG. 7, a split-ring resonator 78 is mounted on the substrate 68. Resonator 78 has a discharge gap 80 and is connected to a source of microwave energy, for example, the microwave power supply 82 shown in FIG. 6. Connection to the power supply 82 is made via a quarter wavelength stripline 84, shown in FIG. 7. When microwave energy is supplied to the resonator 78, a plasma-forming gas present in the discharge gap 80 is converted to a plasma that emits photons in a wavelength range that depends on the properties of the gas. An inlet vent 86 extends through the substrate 68 and is aligned with the discharge gap 80. The plasma-forming gas flows through the inlet vent 86 into the discharge gap.

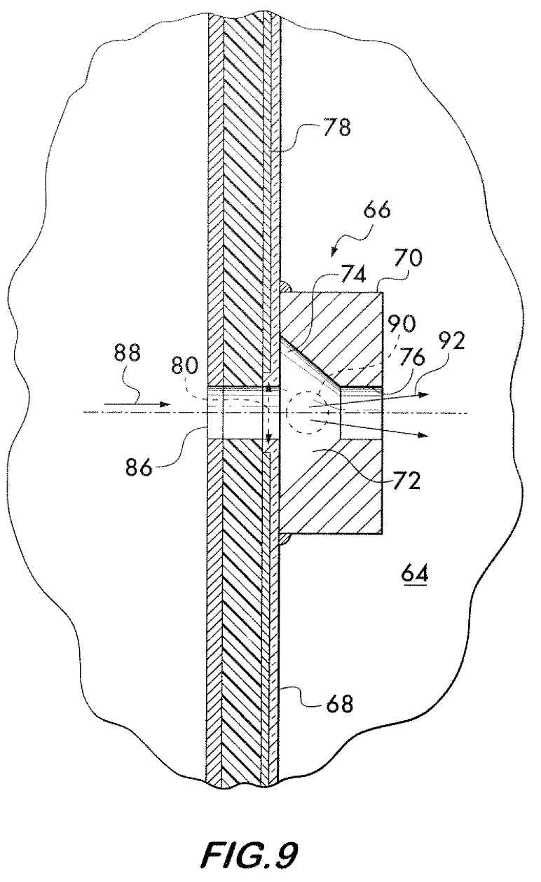

As shown in FIG. 8, the plasma containment structure 70 is mounted on the substrate 68 overlying the discharge gap 80 of the resonator 78. As shown in FIG. 9, the inlet aperture 74 of the containment structure 70 is aligned with the discharge gap 80 and the inlet vent 86 in the substrate 68. Plasma-forming gas 88 enters the discharge gap 89 through the inlet vent 86. Microwave energy supplied to the resonator 78 converts the plasma-forming gas to a photon-emitting plasma 90 in the discharge gap 80. The plasma 90 is then received within the plasma chamber 72 through the inlet aperture 74. Photons 92 generated by the plasma 90 exit the plasma chamber through the windowless outlet aperture 76 into the ionization chamber 64. Because the wavelength of the photons 92 (and thus their energy) depends on the properties of the plasma-forming gas, it is possible to vary the energy of the photons emitted by selecting a particular gas or combination of gases as the plasma-forming gas.

The wavelengths of the ionizing photons are selectable, based upon the selection of the plasma-forming gas. Judicious selection of the plasma-forming gas allows the energy of the photons to be selected so that the photons have sufficient energy to ionize molecules of interest without fragmenting them. The ability to produce ions with little or no fragmentation provides a higher concentration of molecular ions from a given sample, thereby making the photoionization device 66 advantageous for use as the first ionization device 14 in an embodiment of the dual mode spectrometer according to the invention. The low fragmentation characteristic of the photoionization device 66 permits the determination of the mass-to-charge ratio of the intact molecule, thereby avoiding trying to infer this from the mass-to-charge ratios of several fragments.

The noble gases, helium, neon, krypton, argon, and xenon are suitable for use as constituents of the plasma-forming gas in the variable energy photoionization device 66 because they can produce intense resonance radiation when excited by collisions with electrons that have been accelerated by the electric field within the discharge gap 80. The choice of noble gas, or a combination of noble gases, provides ionizing photons having wavelengths in a selectable wavelength range. For example, helium has an optical resonance at 58.43 nm and emits photons having energies of 21.22 eV. Krypton has optical resonances at 116.49 nm and 123.58 nm and emits photons with respective energies of 10.64 eV and 10.03 eV. The argon resonance lines are at 104.82 nm (11.83 eV) and 106.67 nm (11.62. eV) whereas xenon exhibits strong resonance emission at 129.56 nm (9.57 eV) and 146.96 nm (8.44 eV). The windowless structure of photoionization device 66 permits full wavelength selectability within this wavelength range. Additionally noteworthy is the capability of the windowless photoionization device 66 to generate photons in the vacuum ultraviolet range below 120 nm with helium as the plasma-forming gas. In addition to the noble gases, a mixed hydrogen/helium plasma, which emits photons at 121.57 nm, is also a candidate for the plasma-forming gas.

Operation of the variable energy photoionization device 66 to ionize molecules without fragmenting them will now be described with reference to FIG. 6. A plasma-forming gas 88 is selected which, in response to microwave energy, will generate ionizing photons having wavelengths (and therefore energies) which will ionize the particular molecules of interest without fragmenting them. The gas 88 is supplied under pressure to a plasma-forming gas plenum 94 adjacent to the substrate 68. The gas 88 passes through the inlet vent 86 to the discharge gap 80. Microwave energy is provided to the split-ring resonator 78 from the power supply 82 and the photon-emitting plasma 90 is formed within the gap and maintained within the plasma chamber 72. Ionizing photons 92 having the selected wavelength or wavelengths are generated by the plasma and exit the plasma chamber 72 through the windowless outlet aperture 76 into the ionization chamber 64. Sample molecules 32 to be ionized without fragmenting them are supplied to the ionization chamber 64 through an ionization chamber inlet 96 where the ionizing photons 92 ionize them. The ions 36 thus formed exit the ionization chamber through an ionization chamber outlet 98 and are available for further separation, ionization and mass spectrometry analysis.

### Exemplary Analysis—Atomic Ion Mode of Operation

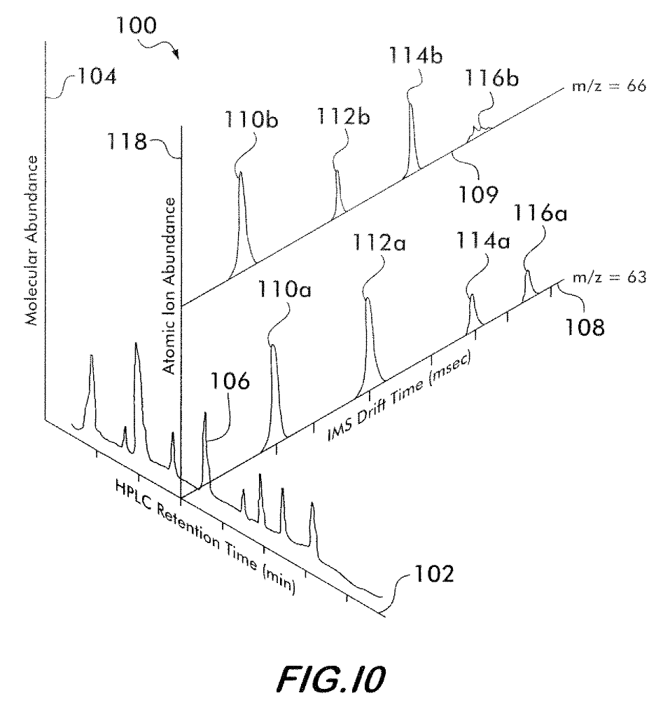

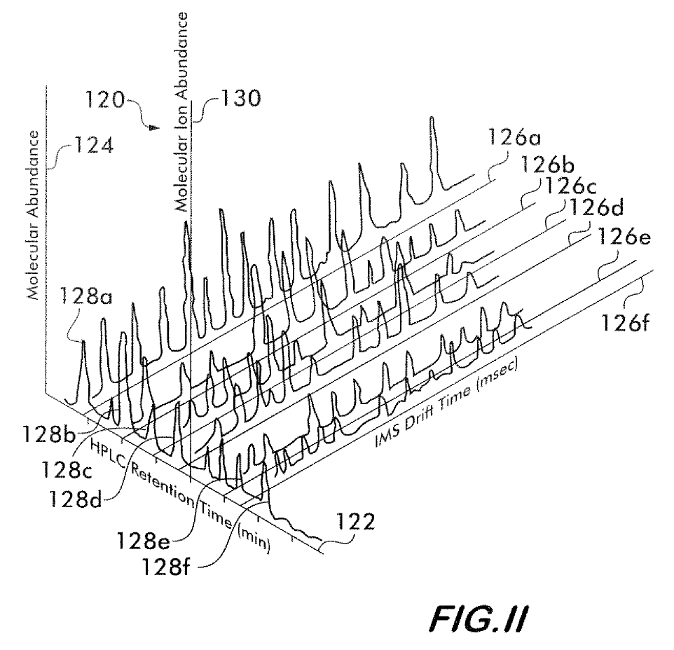

FIG. 10 provides an example of a mass spectrograph 100 which an embodiment of the above-described dual mode mass spectrometer is expected to produce when the second ionization device 18 is in operation for the detection of atomic ions of interest.

The object of the analysis is to identify various isoforms of the protein superoxide dismutase (SOD). This protein has two metal cofactors, copper and zinc. In the standard or “wild” SOD isoform the ratio of zinc to copper is 1:1. Mutant isoforms of SOD (i.e., those isoforms having a ratio of zinc to copper different from 1:1) were found to play a key role in ALS (Lou Gehrig's Disease).

It is not possible to differentiate the zinc to copper ratio among isoforms of SOD by HPLC alone. This is because of the large difference between the mass of the copper and zinc atoms and the molecular weight of the SOD protein. HPLC cannot resolve the small mass difference among large SOD molecules which arises because one or two copper or zinc atoms are missing from the molecule, as would be the case between the so called “wild” or standard SOD isoform and the mutant isoform associated with ALS.

Data which are expected to be derived from the dual mode mass spectrometer shown in FIG. 3 are displayed in plot 100 of FIG. 10. With reference to both FIGS. 3 and 10, a sample 30 containing SOD isoforms is pumped by pump 29 into the high performance liquid chromatograph 28. A buffer with pH in the range of 5-7.5 is typically used in the liquid chromatograph because metalloproteins are labile and under standard conditions used in HPLC the metal co-factor tends to drop out from the protein molecule. The retention times of the various molecules in the sample are plotted along the horizontal axis 102 in FIG. 10 and appear as absorption peaks, measured along a vertical axis 104 as determined by an ultraviolet detector operating at a selected wavelength, for example, 214 nm for analysis of peptide bonds and 280 nm for aromatic aminoacids. Based upon its retention time, peak 106 is known to represent the various SOD isoforms. Effluent 32 from the chromatograph 28 is then input to the photoionization device 34 which ionizes the SOD isoforms to form molecular ions 36. The molecular ions 36 are next separated according to their size-to-charge ratio in the ion mobility spectrometer 38. This device separates the various SOD isoforms because the wild isoform, having two copper and two zinc cofactors, is folded and therefore has a smaller cross section than the mutant isoforms. The mutant SOD isoforms lack one or more metal cofactors and are therefore partially unfolded and have a larger cross section. The molecular ions 36 pass through the ion mobility spectrometer 38 at different speeds proportional to their size (smallest pass fastest, largest pass slowest) and thereby form a stream 40 of molecular ions separated in time according to their size, which corresponds to separating the various isoforms from one another. The stream 40 then passes to the inductively coupled plasma torch 42 which subjects the molecular ions in the stream to a high temperature plasma, producing a stream of atomic ions 44 including the metal cofactors of interest, zinc and copper. Note that the time separation effected by the ion mobility spectrometer 38 is preserved in the atomic ion stream 44. If necessary, the atomic ion stream 44 is filtered by a multipole analyzer 46 and a subset 48 of atomic ions from the atomic ion stream 44 is then passed to time-of-flight mass spectrometer 50 where the atomic ions 48 are separated and detected according to their mass-to-charge ratio m/z. Mass spectrometer 50 is set to scan for m/z of 63, corresponding to copper ions, and m/z of 66, corresponding to zinc ions, and the data captured by the mass spectrometer 50 are plotted on axes 108 and 109 that extend orthogonally to the retention time axis 102 at a retention time corresponding to peak 106. Axes 108 and 109 respectively represent the drift time through the ion mobility spectrometer 38 for mass-to-charge ratios of 63 and 66. Plotted orthogonally to each of axes 108 and 109 are the abundance of atomic copper ions are represented by peaks 110a, 112a, 114a and 116a against a vertical axis 118 at m/z=63. The zinc abundance is represented by peaks 110b, 112b, 114b and 116b at m/z=66. By comparing the ratios of the peaks, the ratios of zinc to copper are used to identify the various SOD isoforms. For example, the ratio of peak 110b to 110a is 1:1, indicating the wild SOD isoform with Zn/Cu=1. Mutant isoforms are represented by the ratios of peaks 112b to 112a (Zn/Cu=0.5), 114b to 114a (Zn/Cu=2) and 116b to 116a (Zn/Cu=0). Data along orthogonal axes such as 108 may be plotted for any or all of the HPLC retention time peaks as desired for a particular analysis.

### Exemplary Analysis—Molecular Ion Mode of Operation

FIG. 11 provides an example of a mass spectrograph 120 which an embodiment of the above-described dual mode mass spectrometer is expected to produce when the second ionization device 18 is not in operation for the detection of molecular species of interest. The object of the analysis is to identify the proteins including metalloproteins that are present in a particular sample (i.e., human serum)

Data, which are expected to be derived from the dual mode mass spectrometer shown in FIG. 3, are displayed in plot 120 shown in FIG. 11. With reference to both FIGS. 3 and 11, a sample 30 containing many proteins and metalloproteins is pumped by pump 29 into the high performance liquid chromatograph 28. A buffer with pH in the range of 5-7.5 is typically used in the liquid chromatograph because metalloproteins are labile and, under standard conditions used in HPLC, the metal co-factor tends to drop out from the protein molecule. The retention times of the various molecules in the sample are plotted along the horizontal axis 122 shown in FIG. 11 and appear as absorption peaks, measured along a vertical axis 124 as determined by an ultraviolet detector operating at a selected wavelength, for example, 214 nm for analysis of peptide bonds and 280 nm for aromatic aminoacids. Effluent 32 from the chromatograph 28 is then input to the photoionization device 34 which ionizes the proteins to form molecular ions 36. The molecular ions 36 are next separated according to their size-to-charge ratio in the ion mobility spectrometer 38. This device separates the various isoforms of each protein as well as any coeluting proteins. The molecular ions 36 pass through the ion mobility spectrometer 38 at different speeds proportional to their size (smallest pass fastest, largest pass slowest) and thereby form a stream 40 of molecular ions separated in time according to their size-to-charge ratios. To analyze molecular ions 40 of interest, separated according to their size-to-charge ratio, the inductively coupled plasma torch 42 is not operated, and, if necessary, the molecular ions 40 pass to the multipole mass analyzer 46 which selects a subset 52 of the molecular ions 40.

Note that the time separation effected by the ion mobility spectrometer 38 is preserved in the molecular ion stream 52. The molecular ion stream 52 is then passed to time-of-flight mass spectrometer 50 where the molecular ions are separated and detected according to their mass-to-charge ratios. The data captured by the mass spectrometer 50 are plotted on axes 126a through 126f that extend orthogonally to the retention time axis 122. Axes 126a through 126f, respectively, represent the drift time through the ion mobility spectrometer 38 of each of the peaks 128a through 128f eluting from the HPLC system. The molecular ion abundances that indicate the exact mass of the intact proteins separated by the time-of-flight mass spectrometer 50 are plotted along axis 130, which is orthogonal to each of axes 122 and 126a through 126f.

We claim:

1. A dual mode mass spectrometer, comprising:
a first separation device for separating sample molecules from one another;
a first ionization device in fluid communication with said first separation device for ionizing said sample molecules into molecular ions after separation of said sample molecules in said first separation device;
a second separation device in fluid communication with said first ionization device for separating said molecular ions according to their size-to-charge ratio;
a second ionization device in fluid communication with said second separation device for receiving said molecular ions separated according to their size-to-charge ratio from said second separation device, said second ionization device, when in operation, atomizing said molecular ions received from said second separation device to generate respective atomic ions comprising metal ions of interest; and
a mass spectrometer in fluid communication with said second ionization device, said mass spectrometer receiving said atomic ions from said second ionization device when said second ionization device is in operation, said mass spectrometer otherwise receiving said molecular ions generated by said first ionization device, said mass spectrometer separating and identifying said atomic ions according to their mass-to-charge ratios.

2. The dual mode mass spectrometer according to claim 1, wherein said first separation device comprises one of a high performance liquid chromatograph and a capillary electrophoresis device.

3. The dual mode mass spectrometer according to claim 1, wherein said first ionization device comprises one of an electrospray ionization device and a photoionization device.

4. The dual mode mass spectrometer according to claim 1, wherein said second separation device comprises an ion mobility spectrometer.

5. The dual mode mass spectrometer according to claim 1, wherein said mass spectrometer comprises a time-of-flight mass spectrometer.

6. The dual mode mass spectrometer according to claim 5, additionally comprising a multipole mass analyzer positioned upstream of said time-of-flight mass spectrometer.

7. The dual mode mass spectrometer according to claim 1, wherein said second ionization device comprises an inductively coupled plasma source.

8. A method of analyzing sample molecules comprising metalloproteins, said method comprising:
separating said sample molecules according to their respective retention times;
ionizing said sample molecules into respective molecular ions;
separating said molecular ions according to their size-to-charge ratio;
atomizing said molecular ions into atomic ions comprising metal ions of interest; and
separating said atomic ions according to their mass-to-charge ratio.

9. The method according to claim 8, in which said separating said sample molecules comprises separating said sample molecules by high performance liquid chromatography.

10. The method according to claim 8, in which said separating said sample molecules comprises separating said sample molecules using capillary electrophoresis.

11. The method according to claim 8, in which said ionizing comprises ionizing said sample molecules using one of electrospray ionization and photoionization.

12. The method according to claim 8, in which said separating said molecular ions comprises separating said molecular ions using ion mobility spectrometry.

13. The method according to claim 8, in which said atomizing comprises heating said molecular ions using an inductively coupled plasma.

14. The method according to claim 8, in which said separating said atomic ions comprises separating said atomic ions using time-of-flight mass spectrometry.

15. A method of analyzing sample molecules comprising metalloproteins and identifying both their constituent atomic and molecular species, said method comprising:
separating said sample molecules according to their respective retention times;
ionizing said sample molecules separated according to their respective retention times into respective molecular ions, said molecular ions constituting ions of a first ion type;
separating said molecular ions according to their size-to-charge ratio;
atomizing a portion of said molecular ions separated according to their size-to-charge ratio into atomic ions comprising metal ions of interest, said atomic ions constituting ions of a second ion type; and
sequentially subjecting said ions of each one of said ion types to an identification process to identify said molecular species and said atomic species, said identification process comprising separating said ions of said one of said ion types according to their mass-to-charge ratio and detecting said ions of said one of said ion types separated according to their mass-to-charge ratio.

16. The method according to claim 15, in which said separating said sample molecules according to their respective retention times comprises separating said sample molecules by one of high performance liquid chromatography and capillary electrophoresis.

17. The method according to claim 15, in which said ionizing said sample molecules separated according to their respective retention times comprises ionizing said sample molecules by one of electrospray ionization and photoionization.

18. The method according to claim 15, in which said separating said molecular ions according to their size to charge ratio comprises separating said molecular ions using ion mobility spectrometry.

19. The method according to claim 15, in which said atomizing comprises heating said molecular ions using an inductively coupled plasma.

20. A dual mode mass spectrometer, comprising:
a high performance liquid chromatograph for separating sample molecules according to their retention times therein;
a windowless photoionization device in fluid communication with said chromatograph for ionizing said sample molecules into molecular ions after separation of said sample molecules in said chromatograph;
an ion mobility spectrometer in fluid communication with said photoionization device for separating said molecular ions according to their size to charge ratio;
an inductively coupled plasma torch in fluid communication with said ion mobility spectrometer, said plasma torch, when in operation, for atomizing said molecular ions received from said ion mobility spectrometer to generate respective atomic ions comprising metal ions of interest; and
a time-of-flight mass spectrometer in fluid communication with said plasma torch, said time-of-flight mass spectrometer receiving said atomic ions from said plasma torch when said plasma torch is in operation, said time-of-flight mass spectrometer otherwise receiving said molecular ions generated by said windowless photoionization device, said time-of-flight mass spectrometer separating and identifying said atomic ions according to their mass-to-charge ratios.

21. A dual mode mass spectrometer according to claim 20, further comprising a multipole mass analyzer positioned between said plasma torch and said time-of-flight mass spectrometer.
